(19) United States
(12) Patent Application Publication
(10) Pub. No.: US 2003/0127062 A1
(43) Pub. Date: Jul. 10, 2003

(54) Ahn engine improved rotary engine system and method

(76) Inventor: Min Ho Ahn, Richmond (CA)

Correspondence Address: Min Ho Ahn, 10051 Sidaway Rd., Richmond, BC, V6W IC3, CA

(21) Appl. No.: 10/033,660

(22) Filed: Jan. 2, 2002

(51) Int. Cl. F02B 57/00

(52) U.S. Cl. 123/43 R

(57) ABSTRACT

An internal combustion engine that combines the concepts of a rotary engine with those of a piston engine. This engine can be adapted to embody many different forms to be appropriate for operating environments ranging from small engines up to large engines for use in power plants. The engine is less complex than a conventional reciprocating engine, but more efficient than a conventional rotary engine.

### CROSS REFERENCES TO RELATED APPLICATIONS

Not applicable

### STATEMENT RE: FEDERALLY SPONSORED RESEARCH OR DEVELOPEMENT

Not Applicable

### REFERENCE TO A MICROFICHE APPENDIX

Not Applicable

### BACKGROUND OF THE INVENTION

The predominant internal combustion engine technology on the market today comprises a plurality of fixed pistons connected to a crankshaft. Each piston cycles through an intake stroke, compression stroke, power stroke, and exhaust stroke that results in the piston moving up and down twice for each cycle. The piston is connected to the crankshaft such that the piston moves the crankshaft during the power stroke and the crankshaft moves the piston during the intake, compression, and exhaust strokes. Such engines commonly employ four, six, or eight pistons (cylinders). Such reciprocating engines are relatively bulky, complex, and heavy.

An alternative to a reciprocating internal combustion engine is referred to as the Wankel rotary engine. A Wankel engine is a 4-cylce engine that employs a generally triangular-shaped rotor mounted within an ovoid combustion chamber. The tips of the rotor divide the combustion chamber into three subchambers that change in volume as the rotor rotates. The rotation of the rotor and the shape of the combustion chamber vary the volume and contents of the subchambers such that these chambers perform the intake, compression, and exhaust functions sequentially and continuously. A spark plug is arranged at a predetermined location such that it fires when the chamber containing compressed air and fuel is in communication with the spark plug.

The Wankel rotary engine is much simpler and less complex than a conventional reciprocating engine. The primary problem with the rotary engine is that a seal must be formed between the three points of the rotor and the wall defining the combustion chamber. These seals wear as the rotor rotates, eventually resulting in a less efficient, relatively polluting engine. Accordingly, the Wankel rotary engine has not achieved significant market penetration at the present time. The need thus exists for an engine that combines the simplicity, small size, and lightweight of the Wankel rotary engine with the efficiency of the reciprocating engine.

1. Field of the Invention

The present invention relates to internal combustion engines and more specifically, to an engine that employs oscillating pistons that rotate about a drive shaft.

2. Description of Related Art

Not Applicable

### BRIEF SUMMARY OF THE INVENTION

The present invention is an internal combustion engine that combines the concepts of a rotary engine with those of a piston engine. The present invention may be embodied in many different forms and some of those will be described in detail below. From the following discussion, it should be apparent that the present invention may be embodied in many different forms representing many different combinations and sub combinations of features that will be described individually below. By describing the invention in terms of these features, one of ordinary skill in the art will recognize that certain combinations of these features may be appropriate for operating environments ranging from small engines for use in gardening tools up to large engines for use in power plants. The particular end use will thus dictate which combination and/or arrangement of features is appropriate.

It should be apparent that one object of the present invention is to provide an improved rotary engine system and method.

Another more specific object of the present invention is to provide internal combustion engine systems and methods that have a favorable mix of the following characteristics:

Less complex than conventional reciprocating engines, but more efficient than conventional rotary engines;

Can be manufactured in a variety of configurations depending upon the intended operating environment: and

Can be manufactured relatively simply and inexpensively.

### BRIEF DESCRIPTION OF THE SEVERAL VIEWS OF THE DRAWINGS

FIG. 1 is a section view, taken along lines 1-1 in FIG. 2, depicting a first embodiment of an engine constructed in accordance with, and embodying, the principles of the present invention;

FIG. 2 is a longitudinal section of the engine of FIG. 1 taken along lines 2-2 in FIG. 1;

FIG. 3 is a lateral section view taken along lines 3-3 in FIG. 2;

FIG. 4 is a partial section view taken along lines 4-4 in FIG. 3;

FIG. 5 is a partial section view of an alternative piston configuration that may be used in place of the piston configuration shown in FIG. 4;

FIG. 6 is a lateral section view taken along lines 6-6 in FIG. 7 depicting an alternative gear assembly depicted in FIG. 1;

FIG. 7 is a longitudinal section view of the engine of FIG. 6 taken along lines 7-7 in FIG. 6;

FIG. 8 is a longitudinal section view of yet another exemplary engine assembly employing a plurality of rotary piston assemblies;

FIG. 9 is a lateral section view of yet another exemplary engine assembly that employs pivoting piston members;

FIG. 10 is a lateral section view of yet another engine assembly constructed in accordance with, and embodying, the principles of the present invention;

FIG. 11 is a second lateral section view depicting the piston assemblies employed by the engine of FIG. 10;

FIG. 12 is a lateral section view of yet another exemplary engine constructed in accordance with the principles of the present invention, the view in FIG. 12 being taken along lines 12-12 in FIG. 13;

FIG. 13 is a longitudinal section view of the engine of FIG. 12 taken along lines 13-13 in FIG. 12;

FIG. 14 is a lateral section view taken along lines 14-14 in FIG. 13;

FIG. 15 is a lateral section view taken along lines 15-15 in FIG. 13;

FIG. 16 is a longitudinal section view of the engine of FIG. 12 employing an offset gear configured differently from the offset gear shown in FIG. 13;

FIG. 17 is a section view of the working surface of a piston member in the context of the piston carriage assembly surrounding the piston member;

FIG. 18 is a lateral section view depicting yet another exemplary engine constructed in accordance with the principles of the present invention;

FIG. 19 is lateral section view depicting a gear assembly of yet another exemplary engine of the present invention, FIG. 19 being taken along lines 19-19 in FIG. 20;

FIG. 20 is a longitudinal section view of the engine shown in

FIG. 21 is a lateral section view of an engine constructed in accordance with the present invention in which the piston assemblies cycle more than once during each revolution of the carriage assembly;

FIG. 22 is a lateral section view of an engine similar to that depicted in FIG. 21 but with a different arrangement of intake and exhaust ports;

FIG. 23 is a lateral section view of an engine of the present invention in which each piston goes through its full cycle twice during one revolution of the piston carriage assembly; and

FIG. 24 is a lateral section view of yet another engine of the present invention in which each piston goes through its full cycle five times during one revolution of the piston carriage assembly

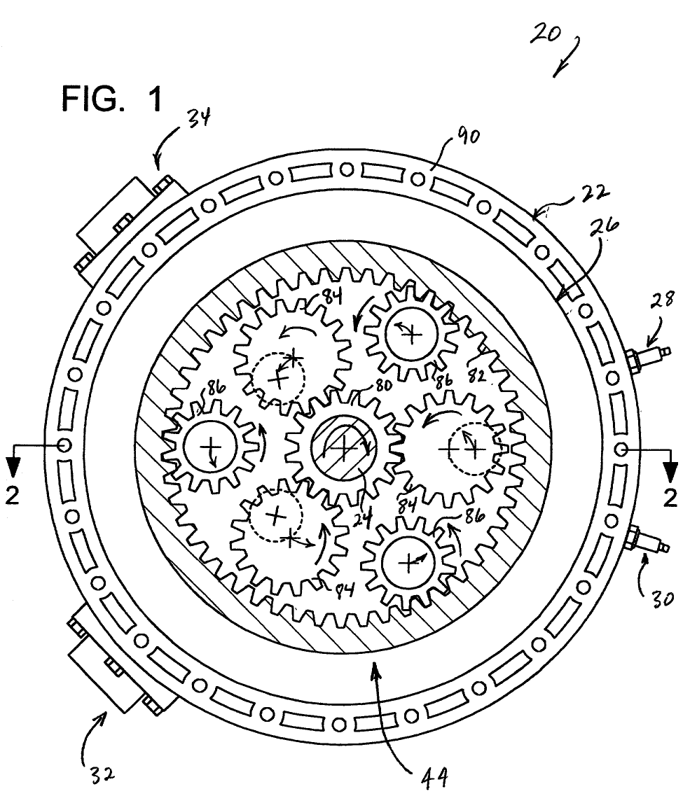

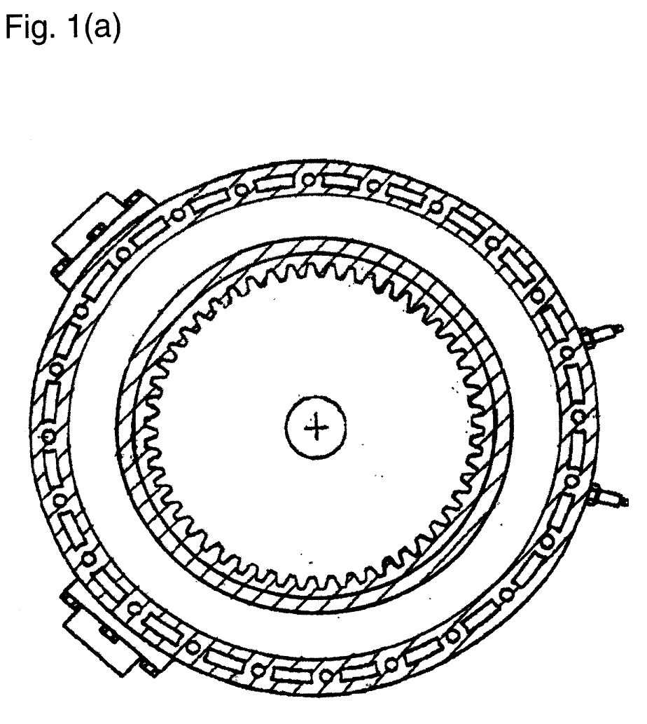

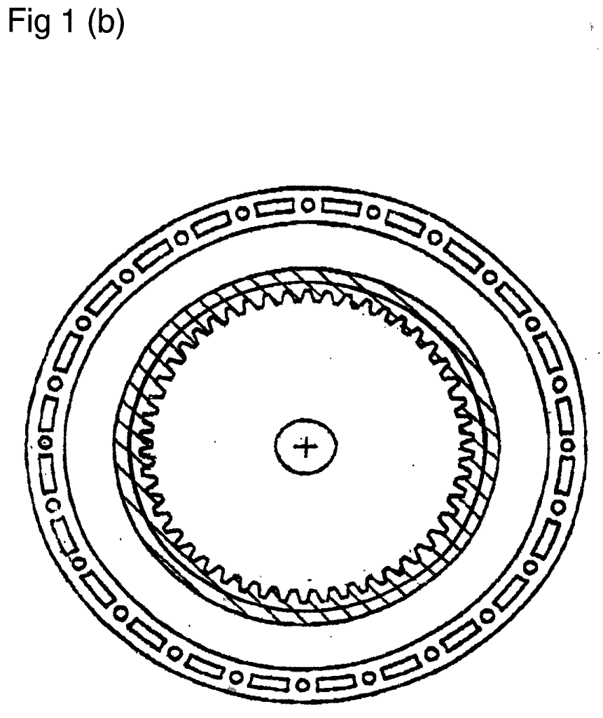

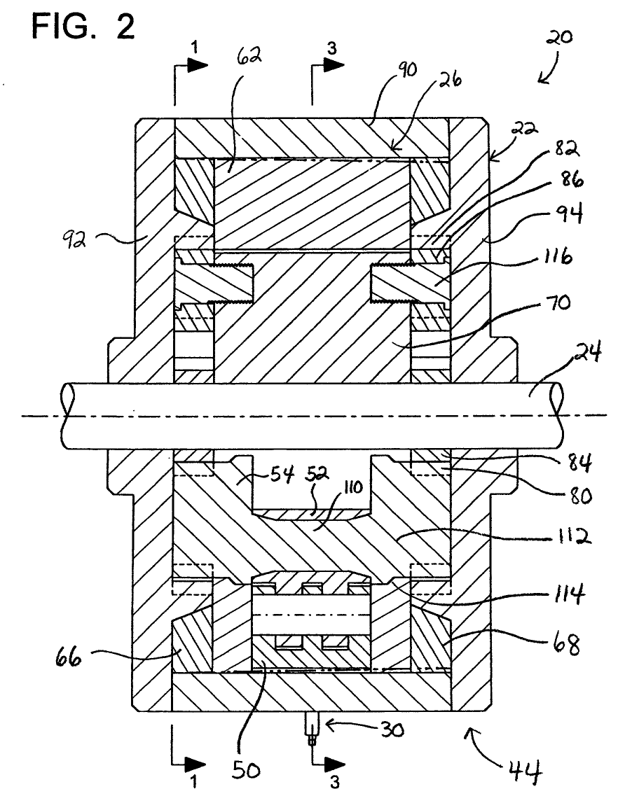

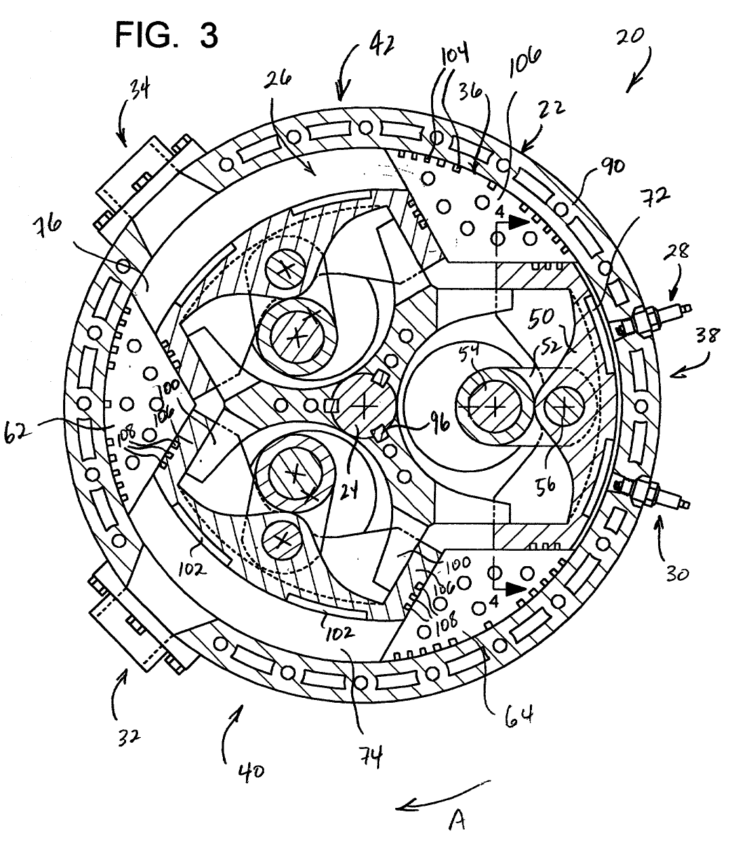

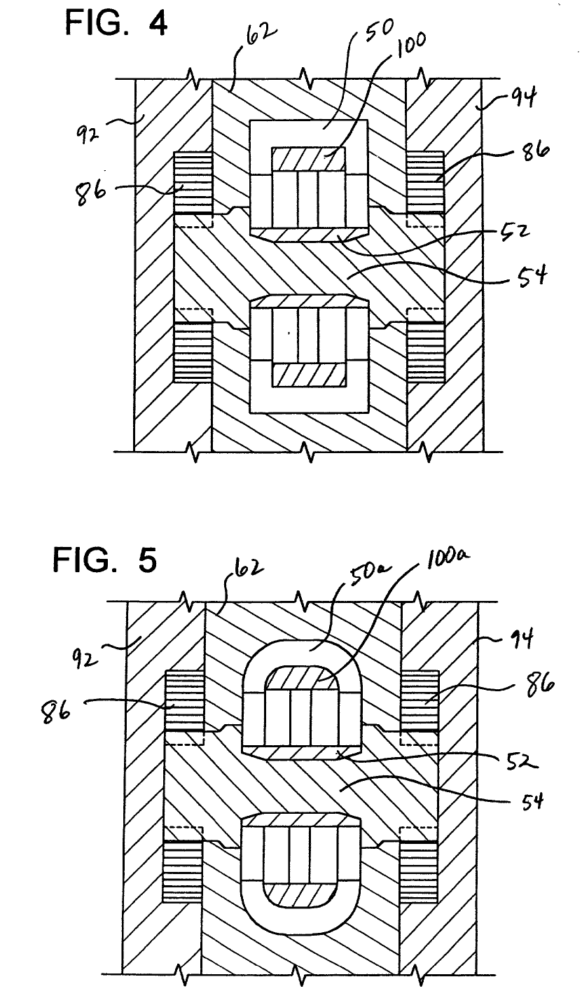

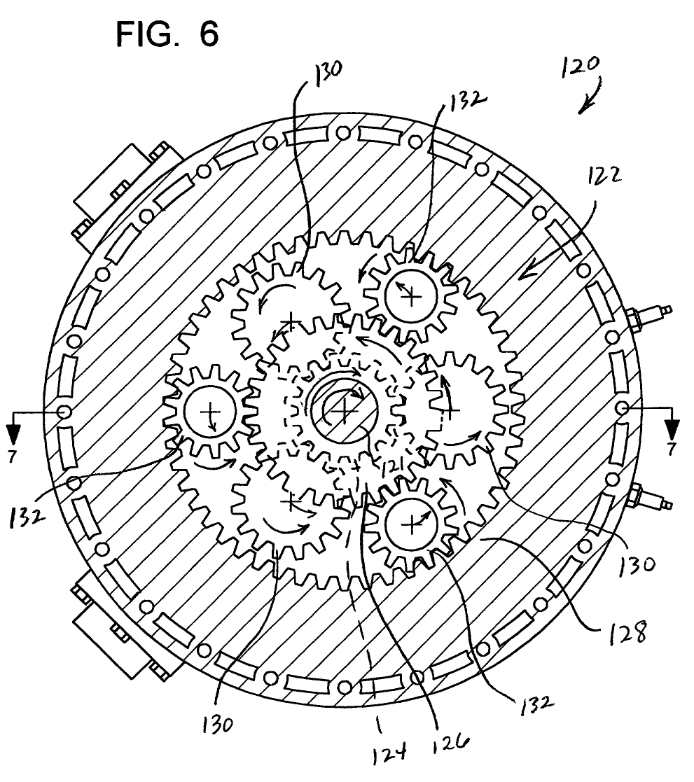

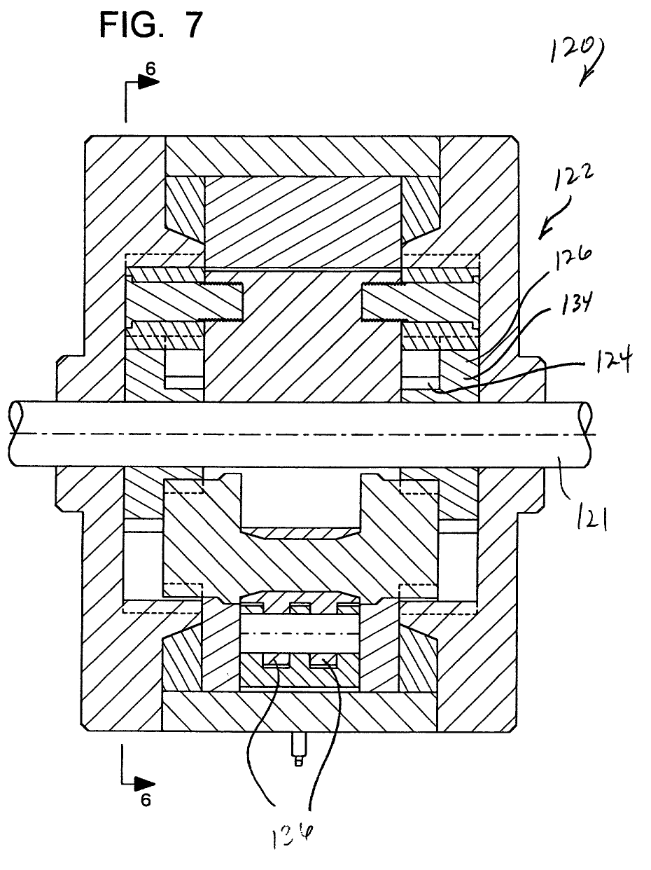

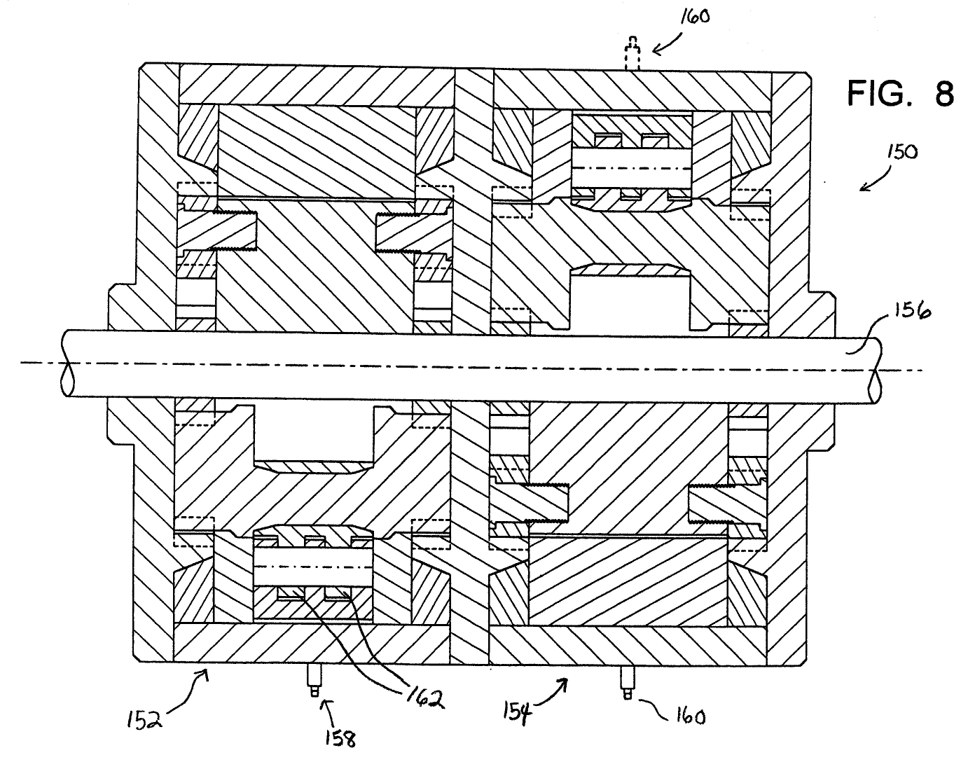

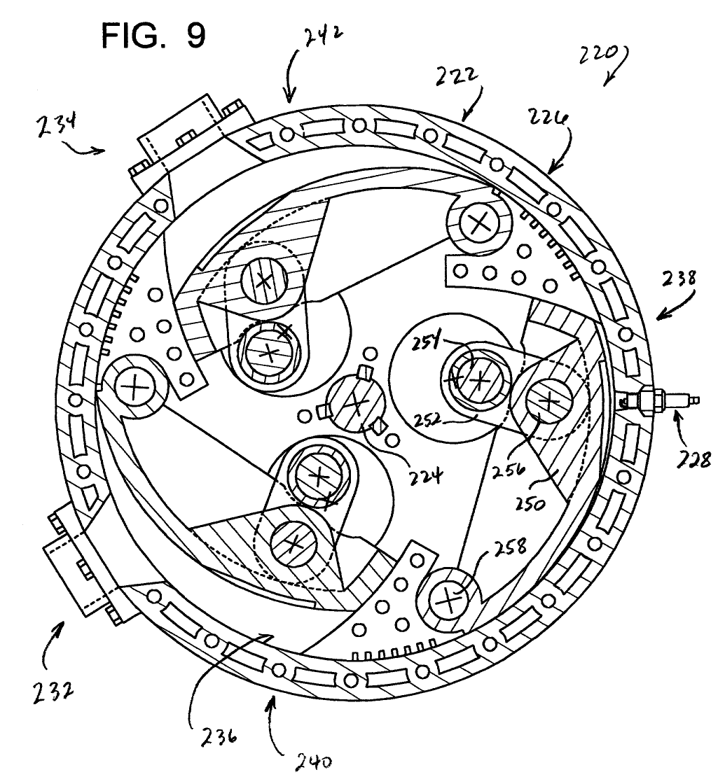

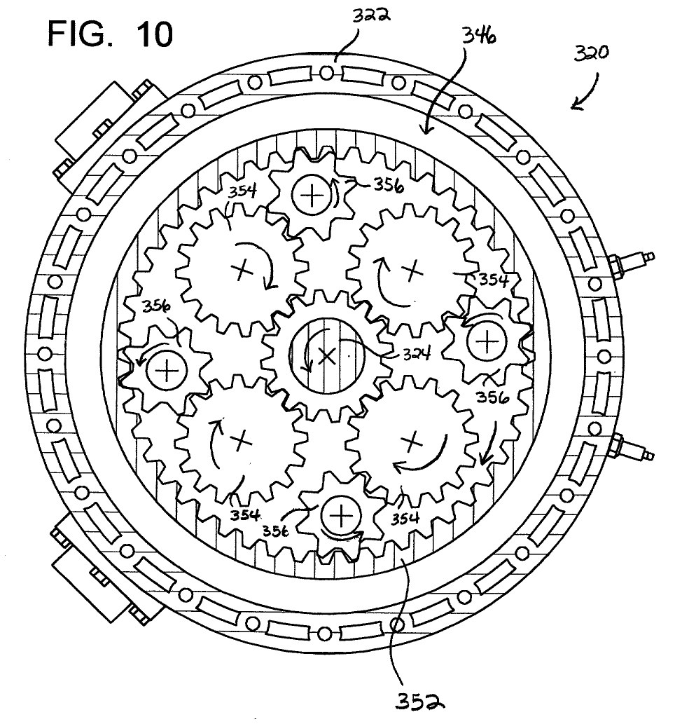

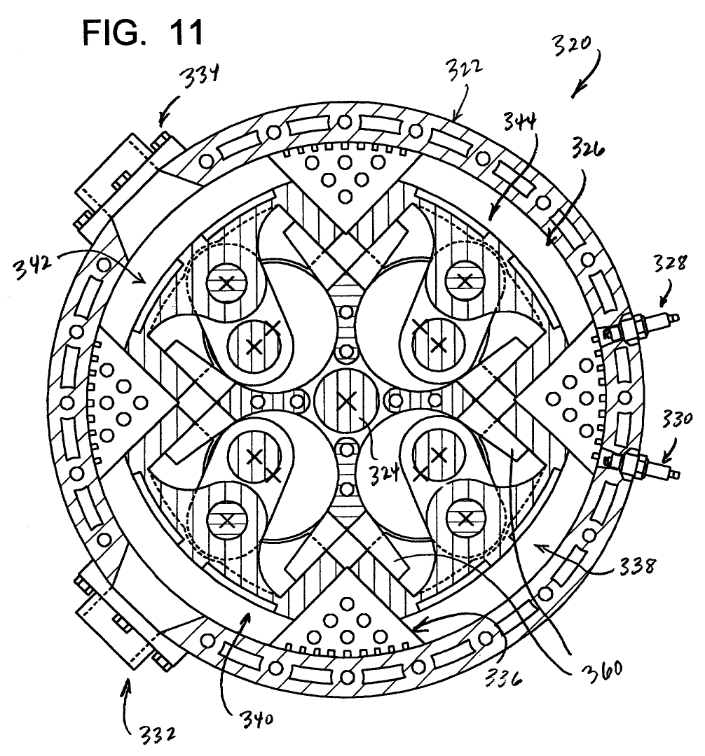

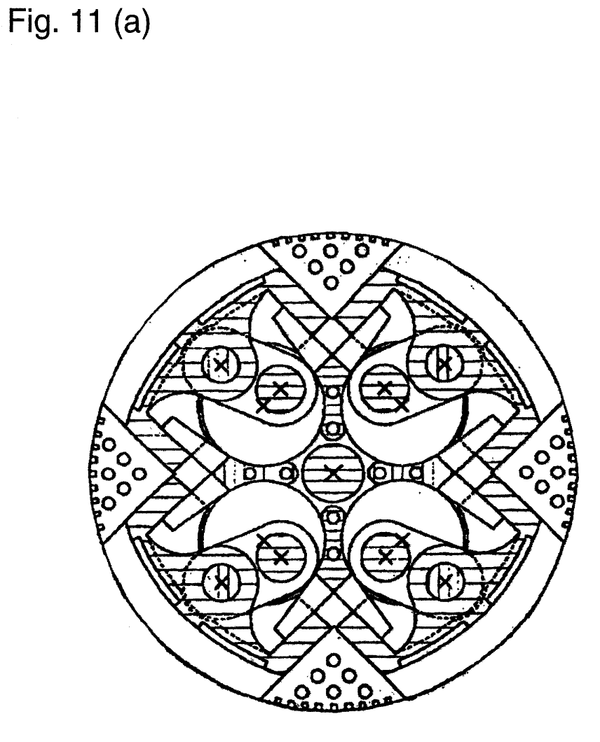

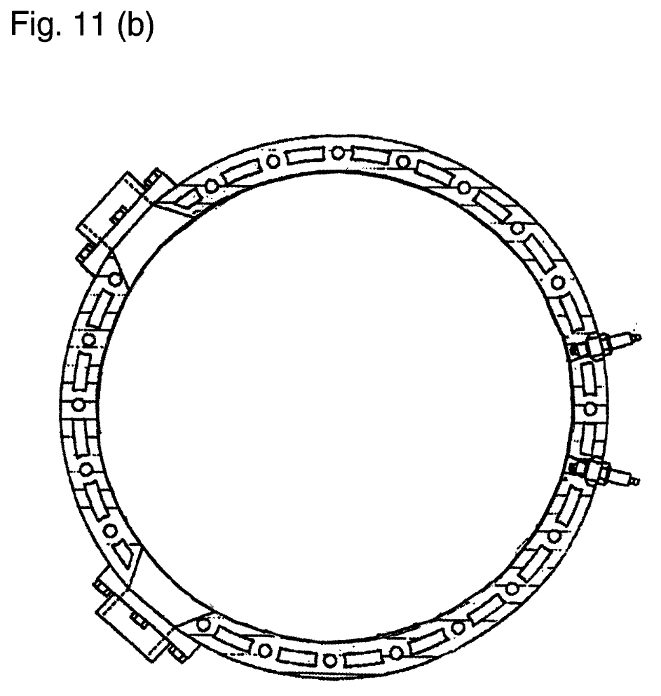

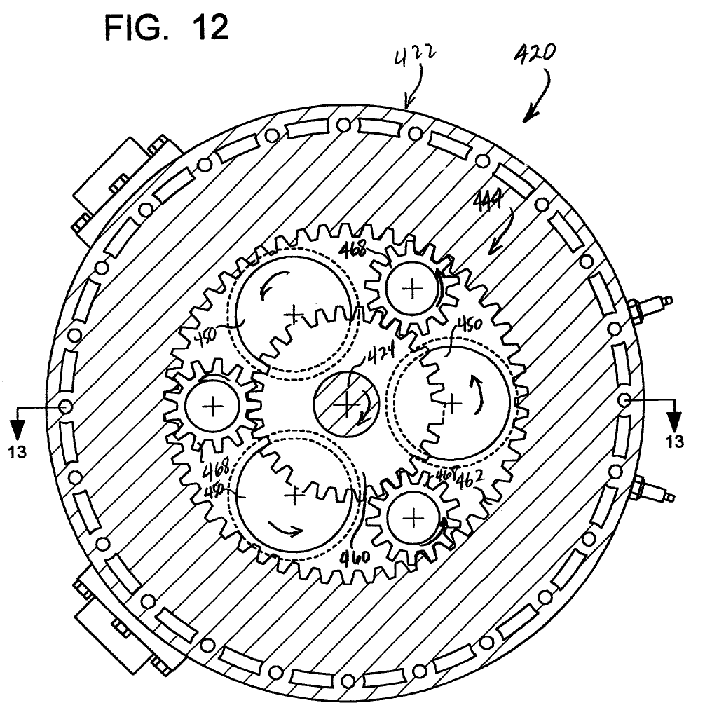

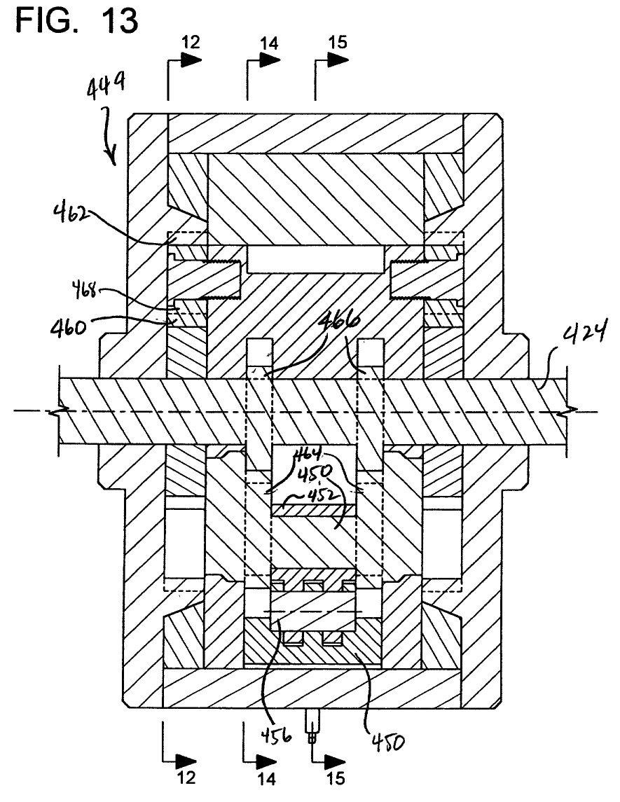

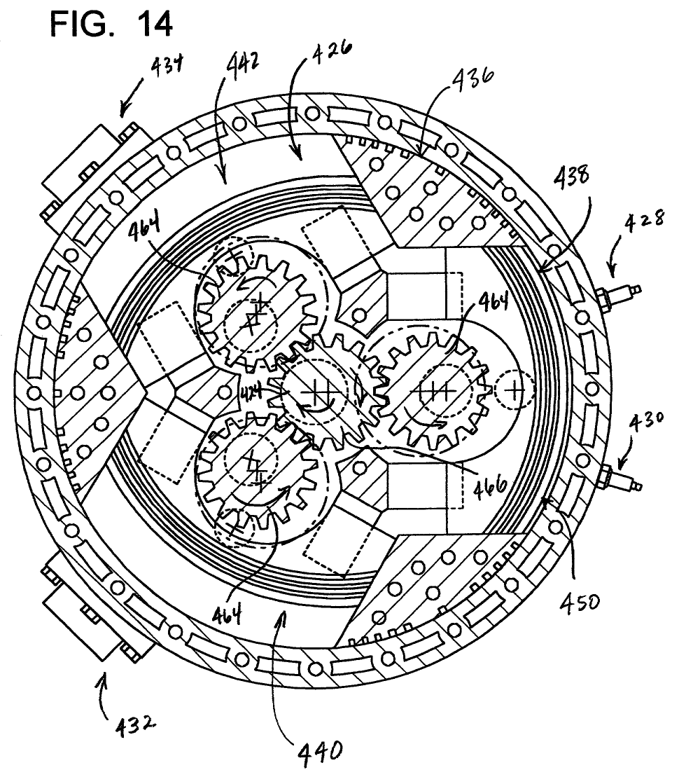

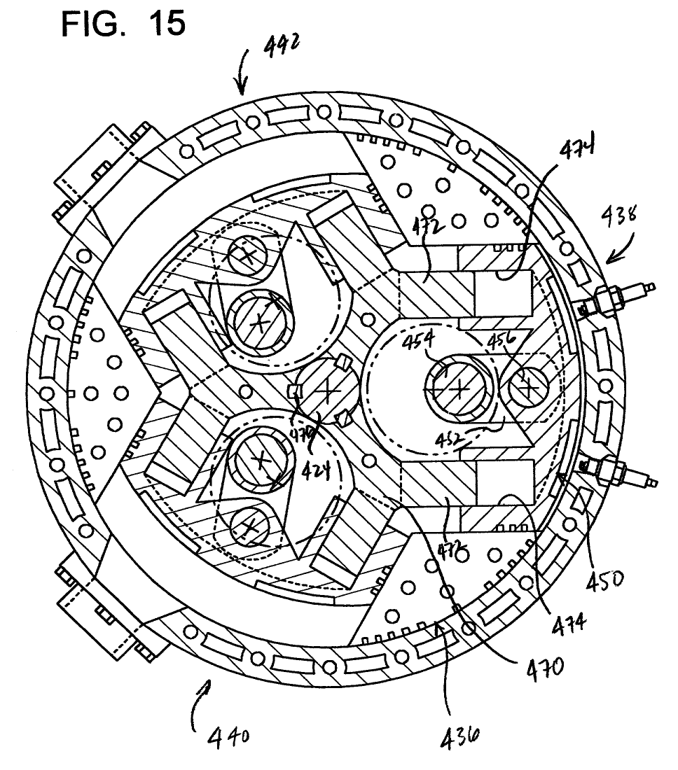

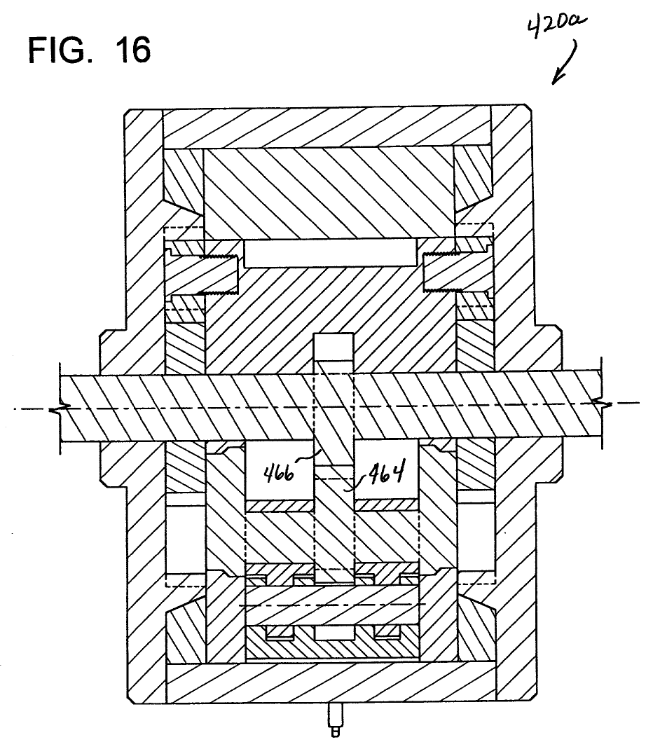

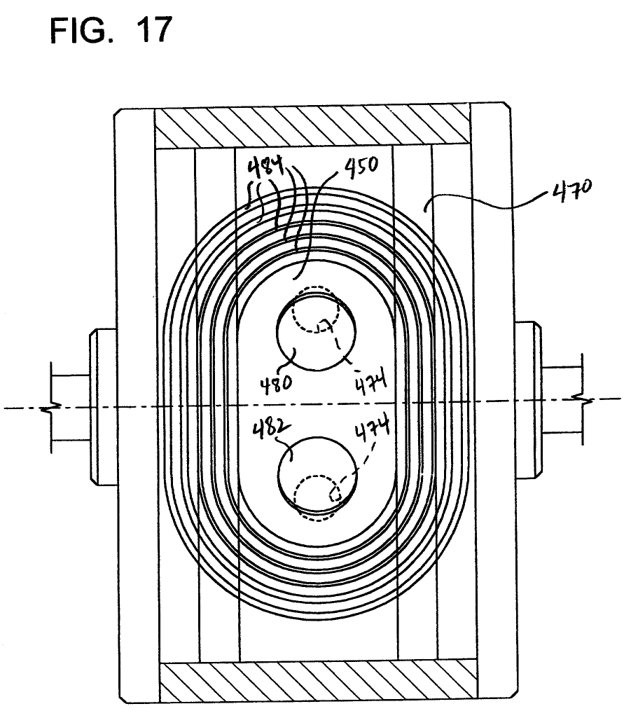

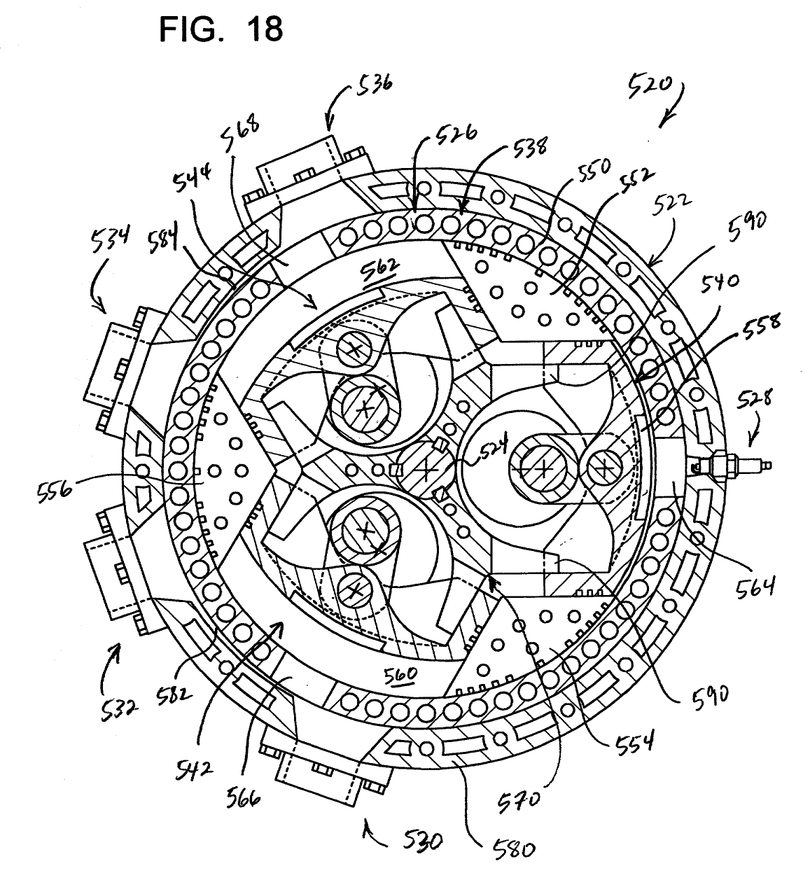

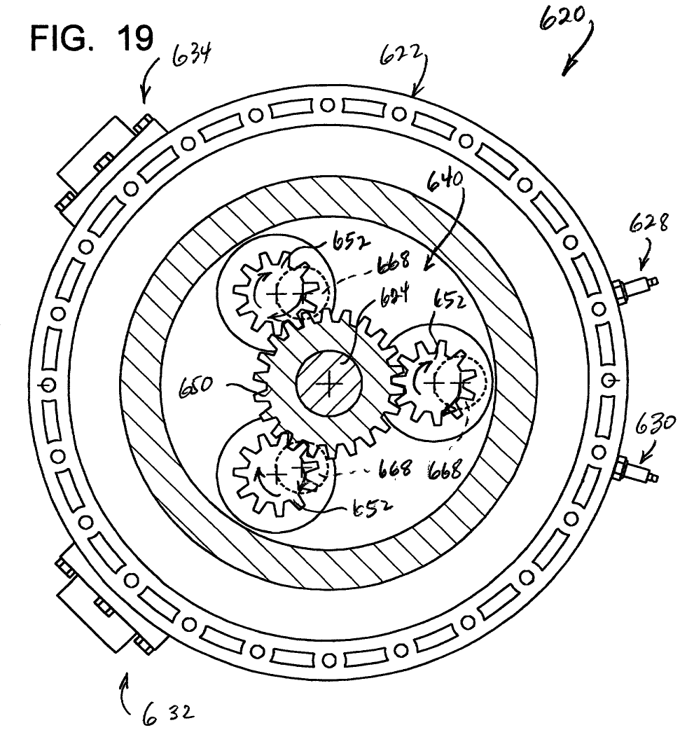

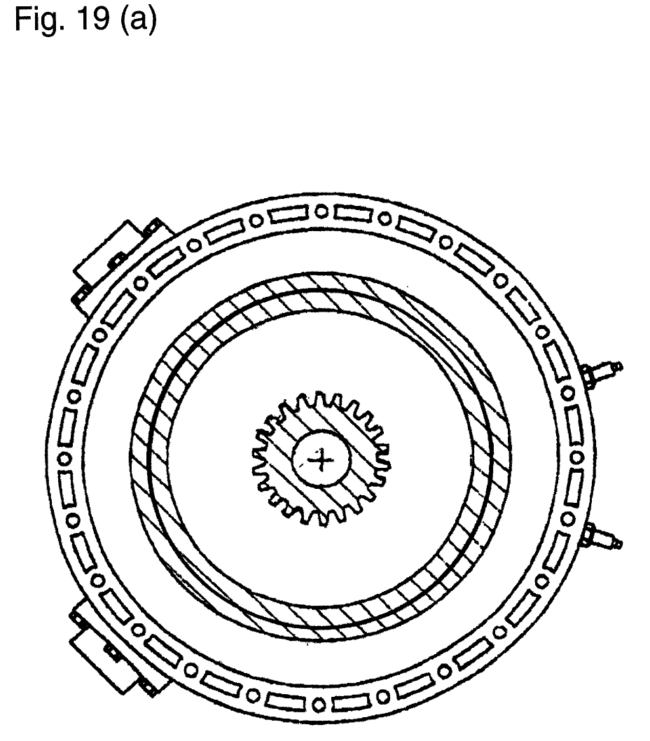

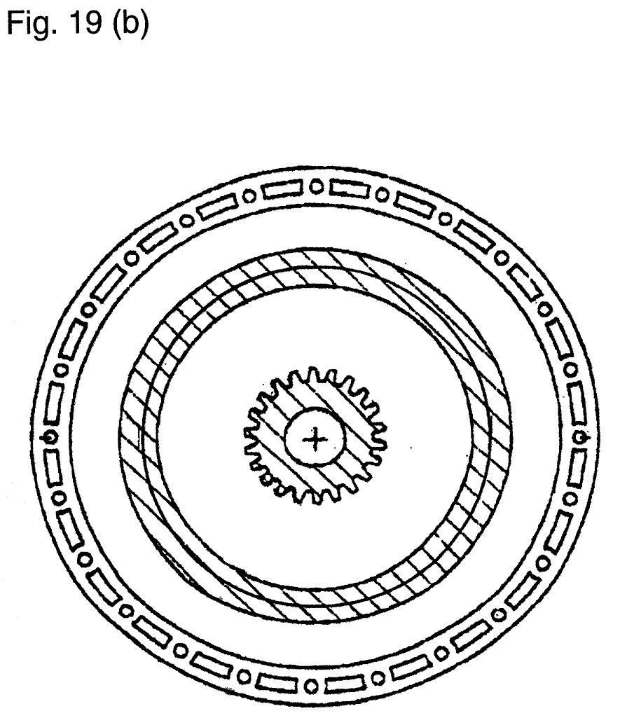

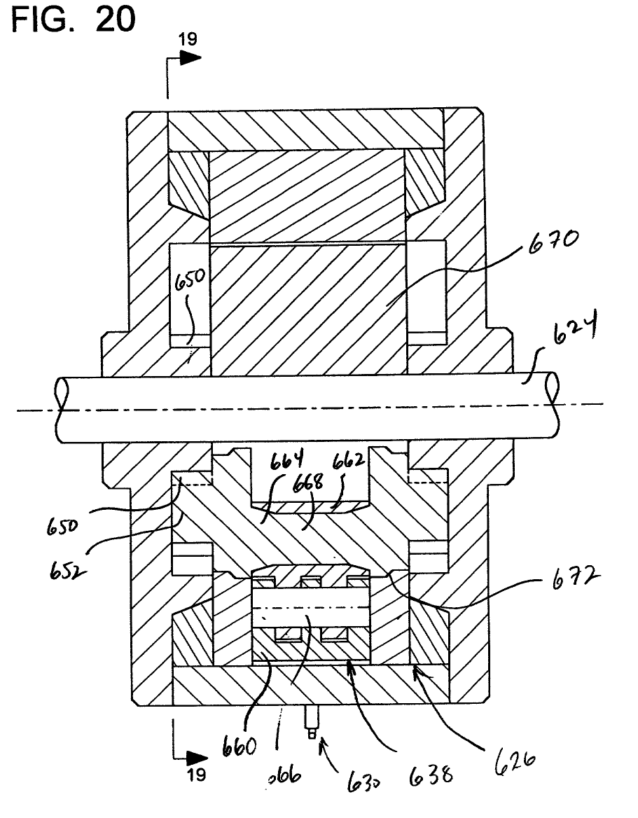

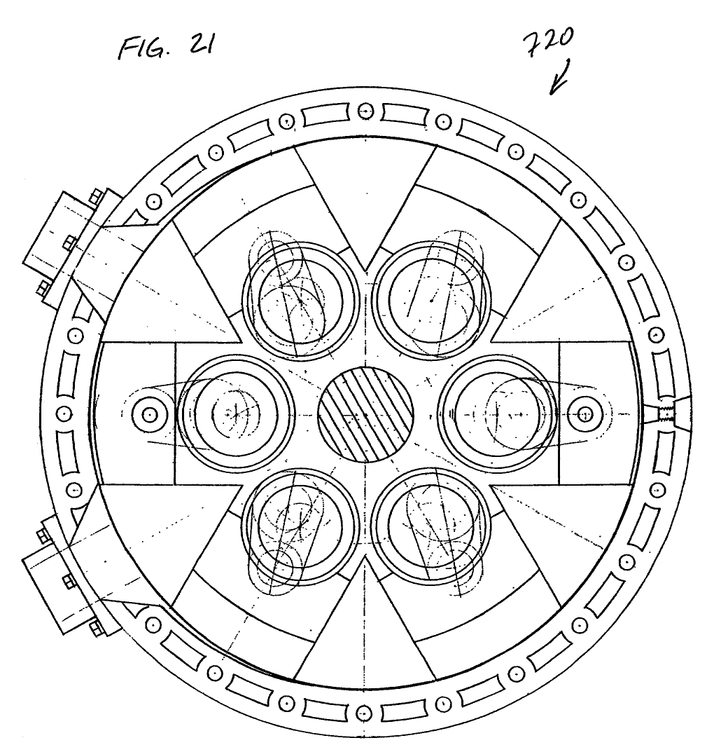

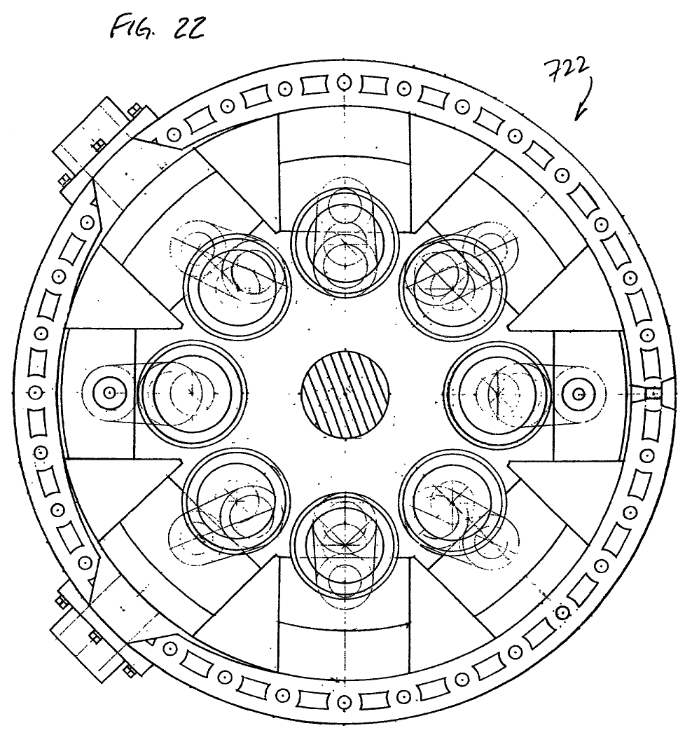

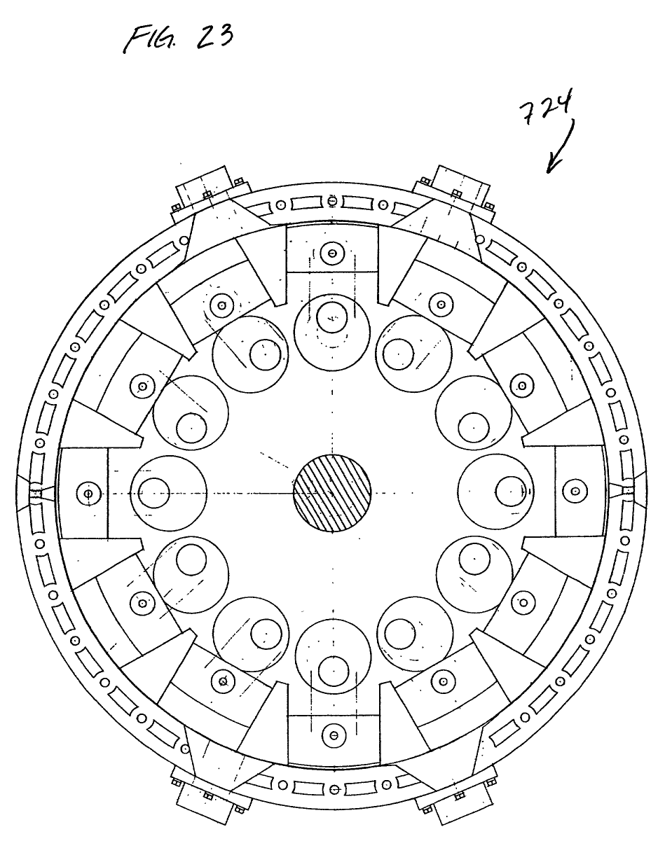

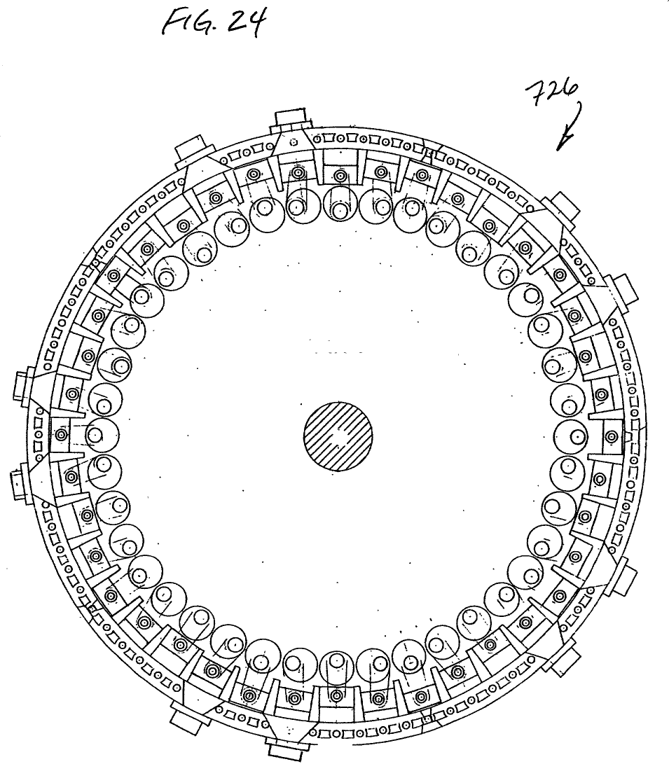

### DETAILED DESCRIPTION OF THE INVENTION

The present invention is an internal combustion engine that combines aspects of a reciprocating piston engine and a turbine-type engine such as the Wankel rotary engine.

The engine of the present invention comprises a case assembly, a shaft, a rotary piston assembly, and a gear assembly. The shaft extends through the case assembly, and the rotary piston assembly is mounted within the case assembly around the shaft. The rotary piston is mounted within the case assembly such that it is capable of rotating about the longitudinal axis of the shaft. The rotary piston assembly is also connected to the shaft, directly and/or indirectly, such that rotation of the rotary piston assembly is transmitted to the shaft.

The rotary piston assembly comprises a piston carriage assembly and a plurality of piston assemblies. The piston carriage assembly is, essentially, a structural member that carries the piston assemblies around the shaft. The piston assemblies are mounted on the piston carriage assembly such that they may reciprocate in a direction of travel that generally radially extends from the shaft. The working surfaces of the pistons face the case assembly such that combustion chambers are formed between the piston working surfaces and the case assembly. Seals are provided between the piston carriage assembly and the case assembly and between the piston assemblies and the piston carriage assembly to allow the pistons to operate in a compression stroke in which the gas fuel mixture within the combustion chamber is compressed and an ignition or power stroke in which the gas fuel mixture is ignited and acts on the piston working surface to force the piston towards the shaft.

The pistons may either be reciprocating members that move directly up and down along radial paths relative to the shaft or rocker-type pistons that reciprocate along a short arc that is generally axially arranged relative to the shaft.

The reciprocating movement of the pistons is transferred into rotary movement of the piston carriage assembly by the gear assembly. The gear assembly is preferably a planetary gear system that includes a power gear for each of the piston assemblies and a fixed gear that the power gears engage. The fixed gear may be a conventional gear coaxially aligned with the shaft, a ring gear coaxially aligned with the shaft, or an offset gear rigidly connected to the shaft.

The piston assemblies each comprise a piston member that reciprocates or rotates along a guided path. As suggested above, the reciprocating motion of the piston member is transmitted through a piston shaft to a piston yoke and then to a piston gear member. The piston gear member has an offset central portion that revolves about the axis of the piston gear member with one end of the piston yoke. At least one, and preferably two, power gears are formed on the piston gear member such that the power gears rotate with rotation of the piston gear member. The longitudinal axis of the piston gear member is the same as the longitudinal axis of the power gear. The central portion of the piston gear member described above is offset from the axis of the piston gear member.

The present invention may be embodied in any one of a number of different configurations depending on its intended operating environment. For example, two or more rotary piston assemblies may be mounted in a single shaft to provide additional power and more balanced operation. Each rotary piston assembly may carry multiple pistons, with three or four pistons per rotary piston assembly being conventional. However, for large power environments, more piston assemblies, for example, six or eight pistons, may be provided at angularly spaced locations about the shaft so that the piston goes through its compression, ignition, exhaust, and intake strokes two or more times per revolution of the rotary piston assembly.

The gear assembly can be more-or-less complex depending on the power requirements of the engine.

The engine as described herein employs an ignition system comprising spark plugs, an exhaust system, a fuel system comprising a carburetor or fuel injector, and a cooling system such as cooling oil. These external systems may be conventional, and adapting such conventional external systems to operate with the engine of the present invention would be well within the skill of one of ordinary skill in the art.

An engine constructed in accordance with the principles of the present invention thus has some of the simplicity of a Wankel rotary engine in that it does not require a complicated set of valves and related mechanics for the intake and exhaust strokes of the piston assemblies. Instead, the rotation of the rotary piston assembly past fixed exhaust and intake ports will perform the valve functions. The present invention thus can be manufactured less expensively and more reliably than the conventional reciprocating internal combustion engine.

While perhaps not as simple in construction as the Wankel rotary engine, an engine of the present invention will be less susceptible to failure or inefficient operation due to failure of seals and the like. The piston carriage assembly defines a generally cylindrical surface around the piston chambers that closely matches the internal surface of the case assembly. Accordingly, rather than having a seal formed at the juncture of an edge and a wall, the seal may be formed at the juncture of two closely matching walls.

The geometry of the engine (i.e., the cylindrical piston carriage assembly and cylindrical case assembly) thus allows conventional ring seals to be used. In particular, conventional ring seals may be formed in the piston carriage assembly about the piston chambers to seal the chambers for the ignition and compression strokes. This will allow more complete combustion during the ignition stroke with less opportunity for dirty, inefficient operation.

The invention of the present invention thus combines many of the positive aspects of a Wankel rotary engine with the positive aspects of a reciprocating engine.

Another benefit of the present invention is that the entire piston carriage assembly and piston assemblies mounted thereon act as a flywheel as they rotate about the shaft. This flywheel action allows the engine to operate more smoothly than a reciprocating engine of comparable output power.

Other advantages of the present invention will be apparent from the following detailed discussion.

1. An engine comprising:
A case assembly;
A shaft extending through the case assembly, where the shaft defines a shaft longitudinal axis;
A rotary piston assembly comprising a piston carriage assembly mounted to the shaft within the case assembly such that the piston carriage assembly rotates about the shaft longitudinal axis;
A plurality of piston assemblies mounted for reciprocating movement on the piston carriage assembly; and a gear assembly operatively engaged with the case assembly and the piston assemblies such that reciprocating movement of the piston assemblies is converted into rotational movement of the piston carriage assembly;
A carriage seal for each piston assembly for sealing a gap between the piston carriage assembly and the case assembly; and a piston seal for each piston assembly for sealing a gap between the piston carriage assembly and the piston assembly; wherein the piston assemblies reciprocate through an intake stroke, a compression stroke, an ignition stroke, and an exhaust stroke as the piston carriage assembly rotates about the shaft longitudinal axis.

2. An engine as recited in claim 1, further comprising an intake port and an exhaust port formed in the case assembly and a spark plug mounted on the case assembly.

3. An engine as recited in claim 1, in which the piston assemblies further comprise:
A piston member mounted for reciprocating movement to the piston carriage assembly;
A piston gear member mounted for rotational movement to the piston carriage assembly; and
A piston yoke operatively connected between the piston member and the piston gear member such that reciprocating movement of the piston member is converted into rotational movement of the piston gear member.

4. An engine as recited in claim 3, in which the gear assembly comprises a power gear that is formed on the piston gear member.

5. An engine as recited in claim 4, in which the gear assembly comprises a fixed gear that is fixed relative to the case assembly, where the power gear engages the fixed gear to convert rotation of the power gear into rotation of the piston carriage assembly about the shaft longitudinal axis.

6. An engine as recited in claim 1, in which pluralities of rotary piston assemblies are spaced along the longitudinal axis of the shaft.

7. An engine as recited in claim 2, in which the exhaust port, intake port, and spark plug are angularly spaced from each other about the shaft longitudinal axis such that the movement of the rotary piston assembly relative to the exhaust port, intake port, and spark plug is timed to allow the piston assemblies to move through intake, compression, ignition, and exhaust strokes during one revolution of the rotary piston assembly.

8. An engine as recited in claim 7, in which a plurality of exhaust ports, intake ports, and spark plugs are arranged such that the piston assemblies move through intake, compression, ignition, and exhaust strokes more than once during one revolution of the rotary piston assembly.

9. An engine as recited in claim 1, in which:
the piston assembly comprises a piston member; and the piston carriage assembly defines at least one piston guide that engages the piston member to guide the piston member as it reciprocates.

10. An engine as recited in claim 1, in which:
the piston assembly comprises a piston member; and the piston member is rotationally connected to the piston carriage assembly such that the piston member reciprocates through a short arc.
